(19) United States
(12) Patent Application Publication
(10) Pub. No.: US 2007/0126673 A1
(43) Pub. Date: Jun. 7, 2007

(54) Method and system for writing data to MEMS display elements

(76) Inventors: Kostadin Djordjev, San Jose, CA (US); R. Scot Hastings, San Diego, CA (US); Alan Lewis, Sunnyvale, CA (US); Marc Mignard, San Jose, CA (US); William J. Cummings, Millbrae, CA (US)

Correspondence Address: KNOBBE, MARTENS, OLSON & BEAR, LLP, 2040 MAIN STREET, FOURTEENTH FLOOR, IRVINE, CA, 92614, US

(21) Appl. No.: 11/296,656

(22) Filed: Dec. 7, 2005

(51) Int. Cl. G09G 3/34

(52) U.S. Cl. 345/84

(57) ABSTRACT

Charge balanced display data writing methods use write and hold cycles of opposite polarity during selected frame update periods. Spatial dithering of hold cycle signals can reduce flicker.

### BACKGROUND

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

One embodiment has a method of writing frames of display data to an array of microelectromechanical system (MEMS) display elements. The method includes writing display data to the MEMS display elements to display an image, applying a first series of bias voltages of alternating polarity to a first set of columns or rows of the array of MEMS display elements, and applying a second series of bias voltages of alternating polarity to a second set of columns or rows of the array of MEMS display elements, where the first set of columns or rows is interleaved with the second set of columns or rows such that adjacent columns or rows receive bias voltages of opposite polarity during the applying of the first series and the applying of the second series.

Another embodiment has a method of reducing flicker during a display hold-mode in a bistable display. The method includes applying bias potentials of opposite polarity to adjacent rows and/or adjacent columns of the display.

Another embodiment has a method of driving a plurality of bistable microelectromechanical system (MEMS) display devices. The method includes writing image data to the devices to display an image, applying hold signals to the display devices, where the hold signals are applied to sets of display devices so as to spatially dither differences in light output such that visible flicker is reduced in the display during the applying, where the differences in light output are caused by the application of the hold signals.

Another embodiment has a display device including an array of microelectromechanical system (MEMS) display elements, and a display driver configured to supply signals to rows and columns of the array so as to display an image, to apply a first series of bias voltages of alternating polarity to a first set of columns or rows of the array, and to apply a second series of bias voltages of alternating polarity to a second set of columns or rows, where the first set of columns or rows is interleaved with the second set of columns or rows such that adjacent columns or rows receive bias voltages of opposite polarity during the applying of the first series and the applying of the second series.

Another embodiment has a display device including means for displaying an image, means for supplying signals to rows and columns of the displaying means so as to display an image, means for applying a first series of bias voltages of alternating polarity to a first set of portions of the displaying means, and means for applying a second series of bias voltages of alternating polarity to a second set of portions of the displaying means, where the first set of portions is interleaved with the second set of portions such that adjacent portions of the displaying means receive bias voltages of opposite polarity during the applying of the first series and the applying of the second series.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is a timing diagram illustrating application of opposite write polarities to different frames of display data.

FIG. 9 is a timing diagram illustrating write and hold cycles during a frame update period in a first embodiment of the invention.

FIG. 10 is a timing diagram illustrating write and hold cycles during a frame update period in a first embodiment of the invention.

FIGS. 11A and 11B illustrate an application of interleaved hold potentials on columns of an array.

FIGS. 12A, 12B, and 12C illustrate an application of interleaved hold potentials on both columns and rows of an array.

FIG. 13 is a timing diagram illustrating variable length write and hold cycles during frame update periods.

### DETAILED DESCRIPTION

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

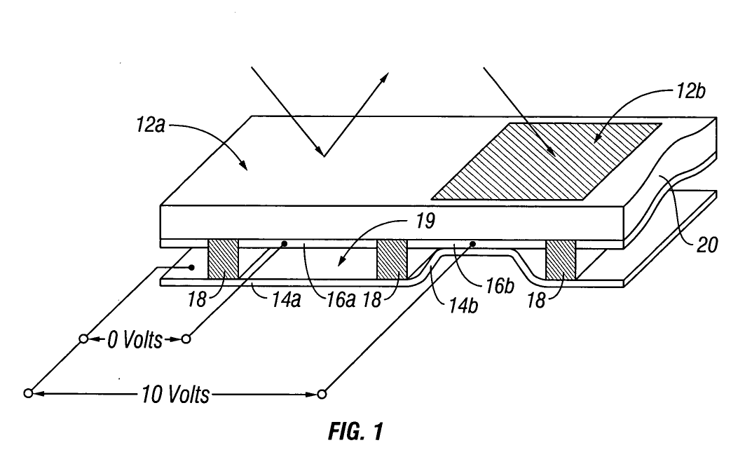

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical cavity with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise of several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the cavity 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

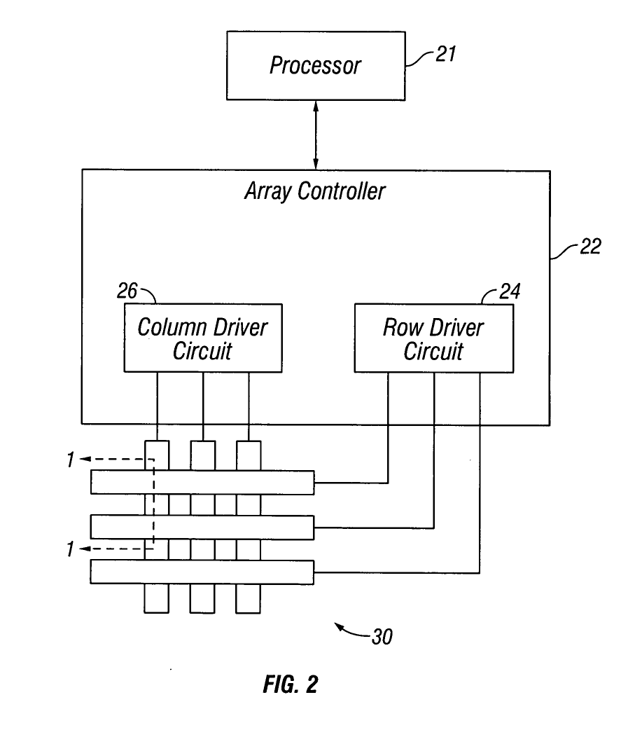

FIGS. 2 through 5 illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

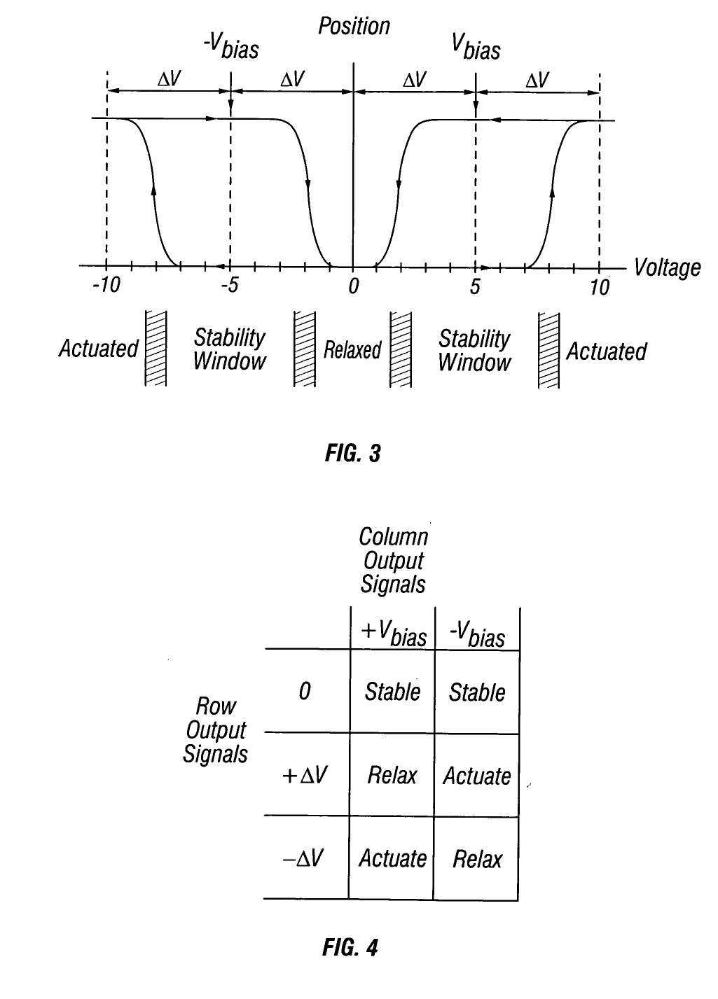

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

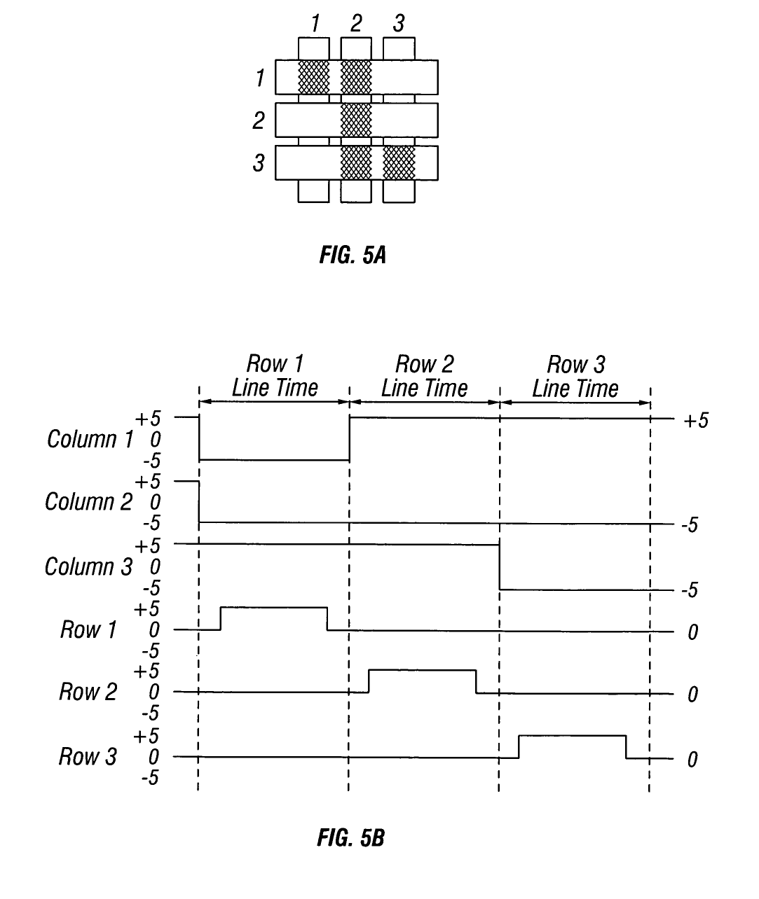

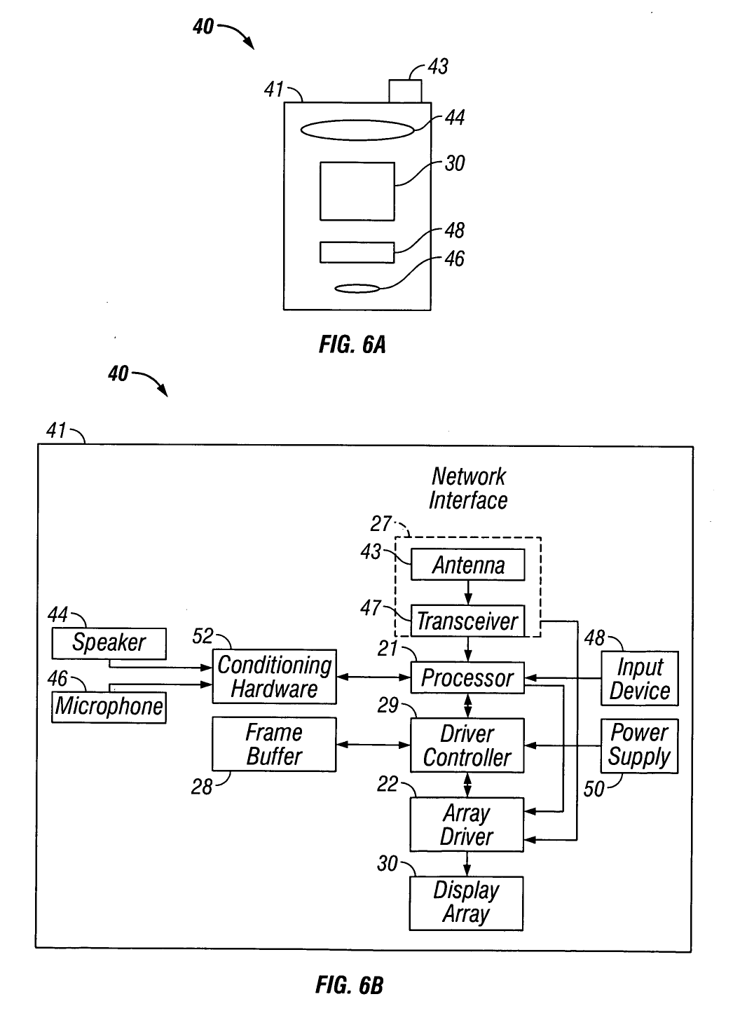

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ÿV, which may correspond to −5 volts and +5 volts respectively Relaxing the pixel is accomplished by setting the appropriate column to +V_{bias}, and the appropriate row to the same +ÿV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ÿV. In this embodiment, releasing the pixel is accomplished by setting the appropriate column to −V_{bias}, and the appropriate row to the same −ÿV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

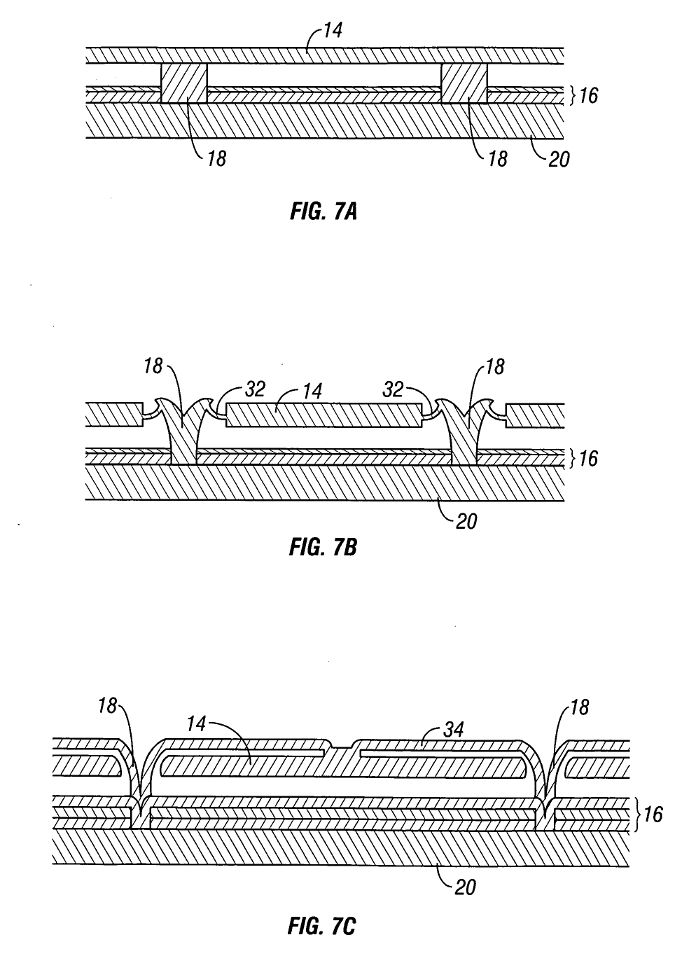

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 44, an input device 48, and a microphone 46. The housing 41 is generally formed from any of a variety of manufacturing processes as are well known to those of skill in the art, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. Those of skill in the art will recognize that the above-described optimization may be implemented in any number of hardware and/or software components and in various configurations.

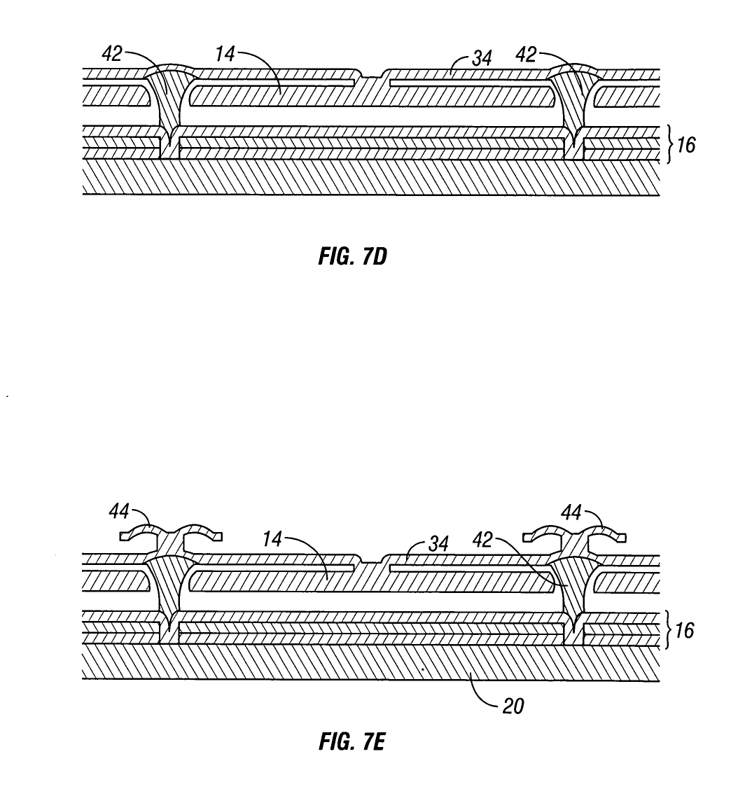

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 is attached to supports at the corners only, on tethers 32. In FIG. 7C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the cavity, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

It is one aspect of the above described devices that charge can build on the dielectric between the layers of the device, especially when the devices are actuated and held in the actuated state by an electric field that is always in the same direction. For example, if the moving layer is always at a higher potential relative to the fixed layer when the device is actuated by potentials having a magnitude larger than the outer threshold of stability, a slowly increasing charge buildup on the dielectric between the layers can begin to shift the hysteresis curve for the device. This is undesirable as it causes display performance to change over time, and in different ways for different pixels that are actuated in different ways over time. As can be seen in the example of FIG. 5B, a given pixel sees a 10 volt difference during actuation, and every time in this example, the row electrode is at a 10 V higher potential than the column electrode. During actuation, the electric field between the plates therefore always points in one direction, from the row electrode toward the column electrode.

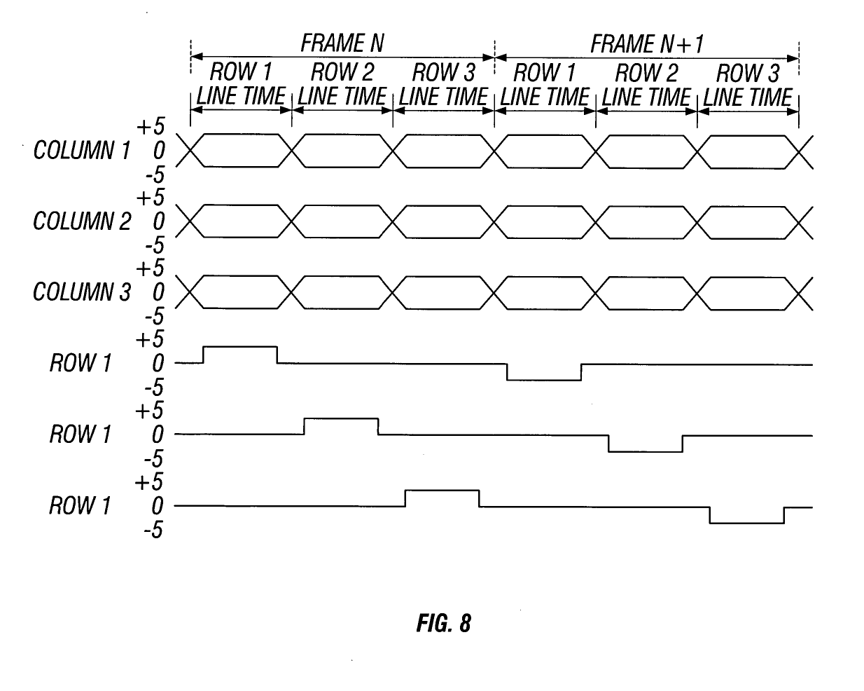

This problem can be reduced by actuating the MEMS display elements with a potential difference of a first polarity during a first portion of the display write process, and actuating the MEMS display elements with a potential difference having a polarity opposite the first polarity during a second portion of the display write process. This basic principle is illustrated in FIGS. 8, 9 and 10.

In FIG. 8, two frames of display data are written in sequence, frame N and frame N+1. In this Figure, the data for the columns goes valid for row 1 (i.e., either +5 or −5 depending on the desired state of the pixels in row 1) during the row 1 line time, valid for row 2 during the row 2 line time, and valid for row 3 during the row 3 line time. Frame N is written as shown in FIG. 5B, which will be termed positive polarity herein, with the row electrode 10 V above the column electrode during MEMS device actuation. During actuation, the column electrode may be at −5 V, and the scan voltage on the row is +5 V in this example. The actuation and release of display elements for Frame N is thus performed according to the center row of FIG. 4 above.

Frame N+1 is written in accordance with the lowermost row of FIG. 4. For Frame N+1, the scan voltage is −5 V, and the column voltage is set to +5 V to actuate, and −5 V to release. Thus, in Frame N+1, the column voltage is 10 V above the row voltage, termed a negative polarity herein. As the display is continually refreshed and/or updated, the polarity can be alternated between frames, with Frame N+2 being written in the same manner as Frame N, Frame N+3 written in the same manner as Frame N+1, and so on. In this way, actuation of pixels takes place in both polarities. In embodiments following this principle, potentials of opposite polarities are respectively applied to a given MEMS element at defined times and for defined time durations that depend on the rate at which image data is written to MEMS elements of the array, and the opposite potential differences are each applied an approximately equal amount of time over a given period of display use. This helps reduce charge buildup on the dielectric over time.

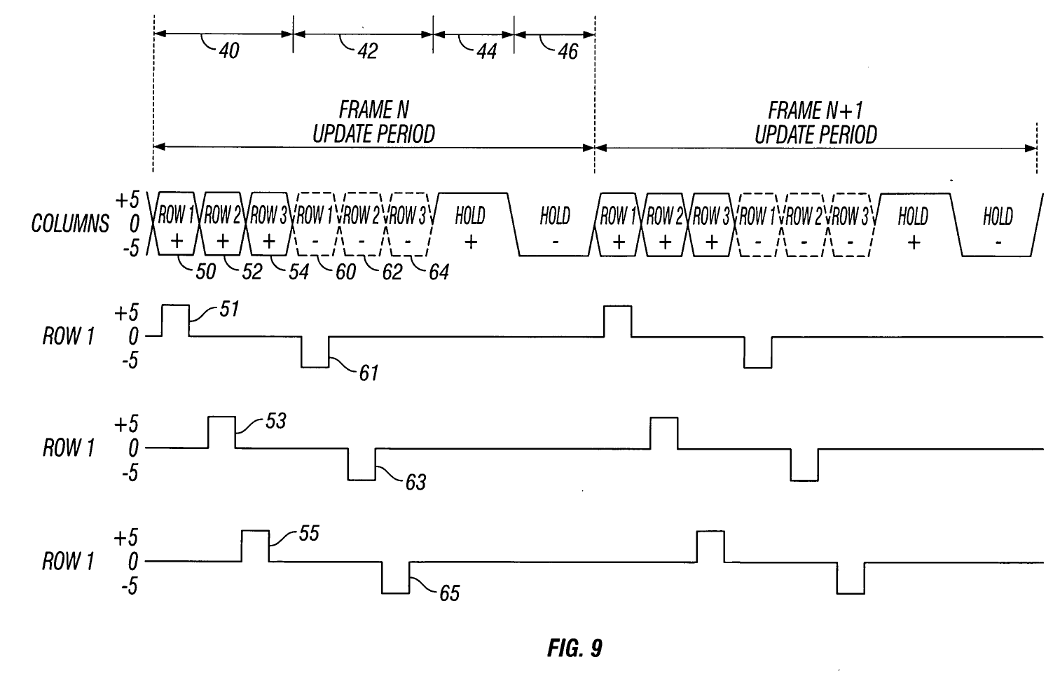

A wide variety of modifications of this scheme can be implemented. For example, Frame N and Frame N+1 can comprise different display data. Alternatively, it can be the same display data written twice to the array with opposite polarities. One specific embodiment wherein the same data is written twice with opposite polarity signals is illustrated in additional detail in FIG. 9.

In this Figure, Frame N and N+1 update periods are illustrated. These update periods are typically the inverse of a selected frame update rate that is defined by the rate at which new frames of display data are received by the display system. This rate may, for example, be 15 Hz, 30 Hz, or another frequency depending on the nature of the image data being displayed.

It is one feature of the display elements described herein that a frame of data can generally be written to the array of display elements in a time period shorter than the update period defined by the frame update rate. In the embodiment of FIG. 9, the frame update period is divided into four portions or intervals, designated 40, 42, 44, and 46 in FIG. 9. FIG. 9 illustrates a timing diagram for a 3 row display, such as illustrated in FIG. 5A.

During the first portion 40 of a frame update period, the frame is written with potential differences across the modulator elements of a first polarity. For example, the voltages applied to the rows and columns may follow the polarity illustrated by the center row of FIG. 4 and FIG. 5B. As with FIG. 8, in FIG. 9, the column voltages are not shown individually, but are indicated as a multi-conductor bus, where the column voltages are valid for row 1 data during period 50, are valid for row 2 data during period 52, and valid for row 3 data during period 54, wherein “valid” is a selected voltage which differs depending on the desired state of a display element in the column to be written. In the example of FIG. 5B, each column may assume a potential of +5 or −5 depending on the desired display element state. As explained above, row pulse 51 sets the state of row 1 display elements as desired, row pulse 53 sets the state of row 2 display elements as desired, and row pulse 55 sets the state of row 3 display elements as desired.

During a second portion 42 of the frame update period, the same data is written to the array with the opposite polarities applied to the display elements. During this period, the voltages present on the columns are the opposite of what they were during the first portion 40. If the voltage was, for example, +5 volts on a column during time period 50, it will be −5 volts during time period 60, and vice versa. The same is true for sequential applications of sets of display data to the columns, e.g., the potential during period 62 is opposite to that of 52, and the potential during period 64 is opposite to that applied during time period 54. Row strobes 61, 63, 65 of opposite polarity to those provided during the first portion 40 of the frame update period re-write the same data to the array during second portion 42 as was written during portion 40, but the polarity of the applied voltage across the display elements is reversed.

In the embodiment illustrated in FIG. 9, both the first period 40 and the second period 42 are complete before the end of the frame N update period. In this embodiment, a pair of alternating hold periods 44 and 46 fill the time after the second period 42 and before the end of the frame N update period. Using the array of FIGS. 3-5 as an example, during the first hold period 44, the rows are all held at 0 volts, and the columns are all brought to +5 V. During the second hold period 46, the rows remain at 0 volts, and the columns are all brought to −5 V. Thus, during the period following array writing of Frame N, but before array writing of Frame N+1, bias potentials of opposite polarity are each applied to the elements of the array. During these periods, the state of the array elements does not change, but potentials of opposite polarity are applied to minimize charge buildup in the display elements.

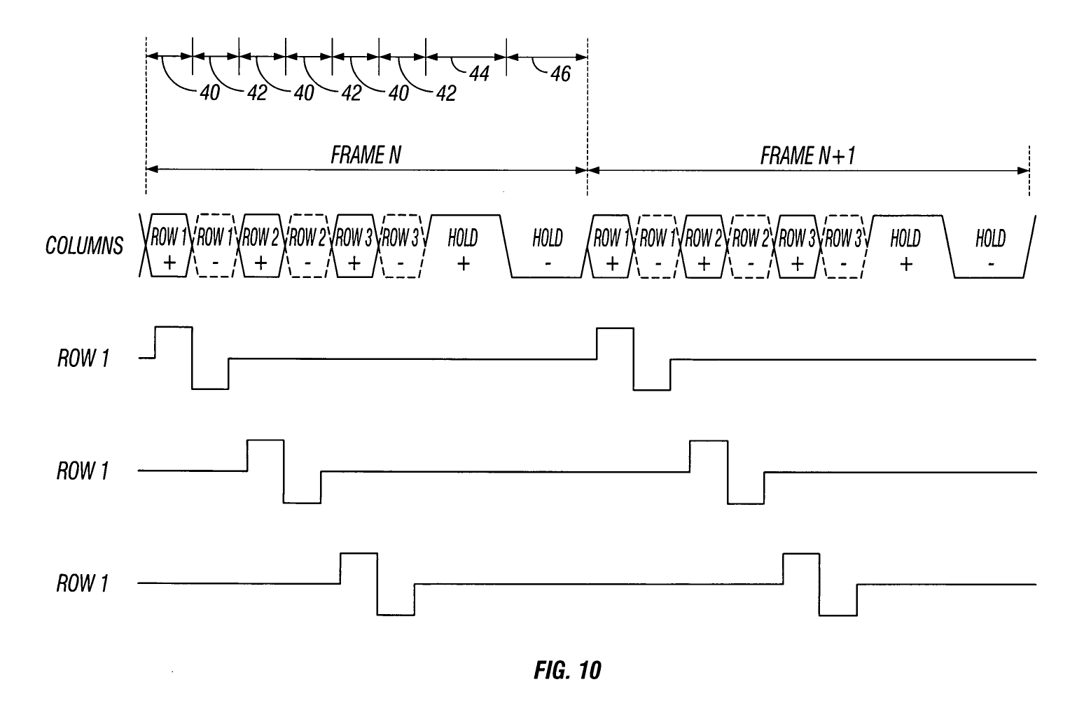

During the next frame update period for Frame N+1, the process may be repeated, as shown in FIG. 9. It will be appreciated that a variety of modifications of this overall method may be utilized to advantageous effect. For example, more than two hold periods could be provided. FIG. 10 illustrates an embodiment where the writing in opposite polarities is done on a row by row basis rather than a frame by frame basis. In this embodiment, the time periods 40 and 42 of FIG. 9 are interleaved. In addition, the modulator may be more susceptible to charging in one polarity than the other, and so although essentially exactly equal positive and negative write and hold times are usually most advantageous, it might be beneficial in some cases to skew the relative time periods of positive and negative polarity actuation and holding slightly. Thus, in one embodiment, the time of the write cycles and hold cycles can be adjusted so as to allow the charge to balance out. In an exemplary embodiment, using values selected purely for illustration and ease of arithmetic, an electrode material can have a rate of charging in positive polarity is twice as fast the rate of charging in the negative polarity. If the positive write cycle, write+, is 10 ms, the negative write cycle, write−, could be 20 ms to compensate. Thus the write+ cycle will take a third of the total write cycle, and the write− cycle will take two-thirds of the total write time. Similarly the hold cycles could have a similar time ratio. In other embodiments, the change in electric field could be non-linear, such that the rate of charge or discharge could vary over time. In this case, the cycle times could be adjusted based on the non-linear charge and discharge rates.

In some embodiments, several timing variables are independently programmable to ensure DC electric neutrality and consistent hysteresis windows. These timing settings include, but are not limited to, the write+ and write− cycle times, the positive hold and negative hold cycle times, and the row strobe time.

While the frame update cycles discussed herein have a set order of write+, write−, hold +, and hold −, this order can be changed. In other embodiments, the order of cycles can be any other permutation of the cycles. In still other embodiments, different cycles and different permutations of cycles can be used for different display update periods. For example, Frame N might include only a write+ cycle, hold+ cycle, and a hold− cycle, while subsequent Frame N+1 could include only a write−, hold+, and hold− cycle. Another embodiment could use write+, hold+, write−, hold− for one or a series of frames, and then use write−, hold−, write+, hold+ for the next subsequent one or series of frames. It will also be appreciated that the order of the positive and negative polarity hold cycles can be independently selected for each column. In this embodiment, some columns cycle through hold+ first, then hold−, while other columns go to hold− first and then to hold+. In one example, depending on the configuration of the column driver circuit, it may be more advantageous to set half the columns at −5 V and half at +5 V for the first hold cycle 44, and then switch all column polarities to set the first half to +5 V and the second half to −5 V for the second hold cycle 46.

Another advantageous aspect of such an embodiment is that if the first and second column halves are properly arranged, the polarities of the hold cycle potentials are alternated spatially across the array. Such spatial alternation of hold cycle polarities helps to eliminate or reduce a disturbance of the displayed image, such as perceptible flicker, which can occur during the hold cycles. The flicker phenomenon occurs because sometimes the hysteresis curves are not exactly centered around zero volts, so that the mechanical response (and thus optical response) of a display element is polarity dependent even when the applied voltages have the same absolute value. Therefore, during the hold cycles, when all of the pixels in the display are switching between positive polarity and negative polarity simultaneously, a visible flicker in the display can result. One possible method of removing the flicker is to increase the frequency of the polarity alternations to be higher than may be perceived by humans. Although effective, this solution requires significant power consumption to drive the higher frequency hold cycle signals.

To overcome this perceptible disturbance without the cost of higher power consumption a spatial dithering technique may be employed. While changing hold potential polarity during the hold period, some embodiments drive the array columns in a particular arrangement so as to horizontally dither the flicker. In a simple embodiment, when even numbered columns are in a positive hold state, odd numbered columns are in a negative hold state, and vice versa.

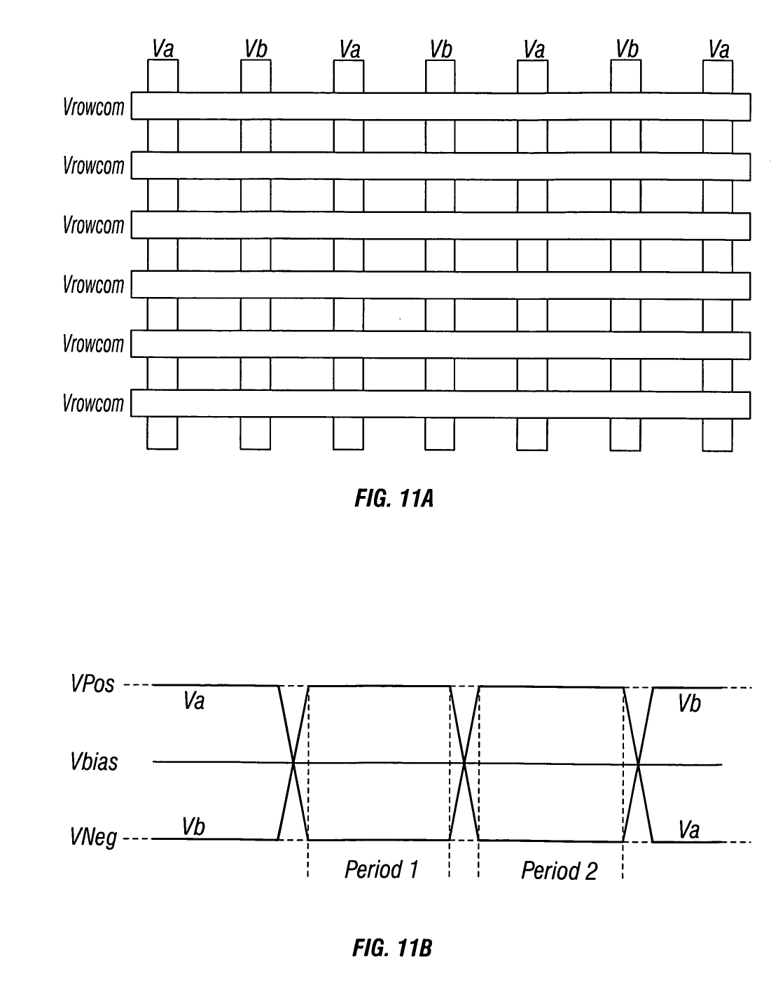

FIGS. 11A and 11B are an illustration and a timing diagram showing an array of interferometric modulators and the drive potentials on the rows and columns during a hold period. FIG. 11A shows that the row hold potential, Vrowcom, is common among the rows. Vrowcom in some useful embodiments is zero or near zero, as in the drive scheme of FIG. 5B, but this is not always the case. FIG. 11A also shows that the column potentials are not all identical. Although other arrangements are possible, in the embodiment shown in FIG. 11A, the column potentials horizontally alternate. That is, even numbered columns have a first potential Vb and odd numbered columns have a second potential Va. Accordingly, the effective potential across any individual interferometric modulator is either |Va−Vbias| (the absolute value of Va−Vbias) or |Vb−Vbias|. As shown in FIG. 11B, Va and Vb alternate between Vpos and Vneg and are driven so that when Va is Vpos, Vb is Vneg, and when Va is Vneg, Vb is Vpos. Because of this column-wise alternating of potentials Va and Vb in an ABAB pattern, horizontally adjacent columns of interferometric modulators will be in opposite polarity hold states. The result is that while the desirable affects of changing drive polarities is achieved, the undesirable flicker is horizontally dithered such that its perception is reduced or substantially eliminated. Flicker reduction may also be obtained with coarser interleaving such as applying Va to a column pair, Vb to an adjacent column pair, and so on, in an AABBAA pattern.

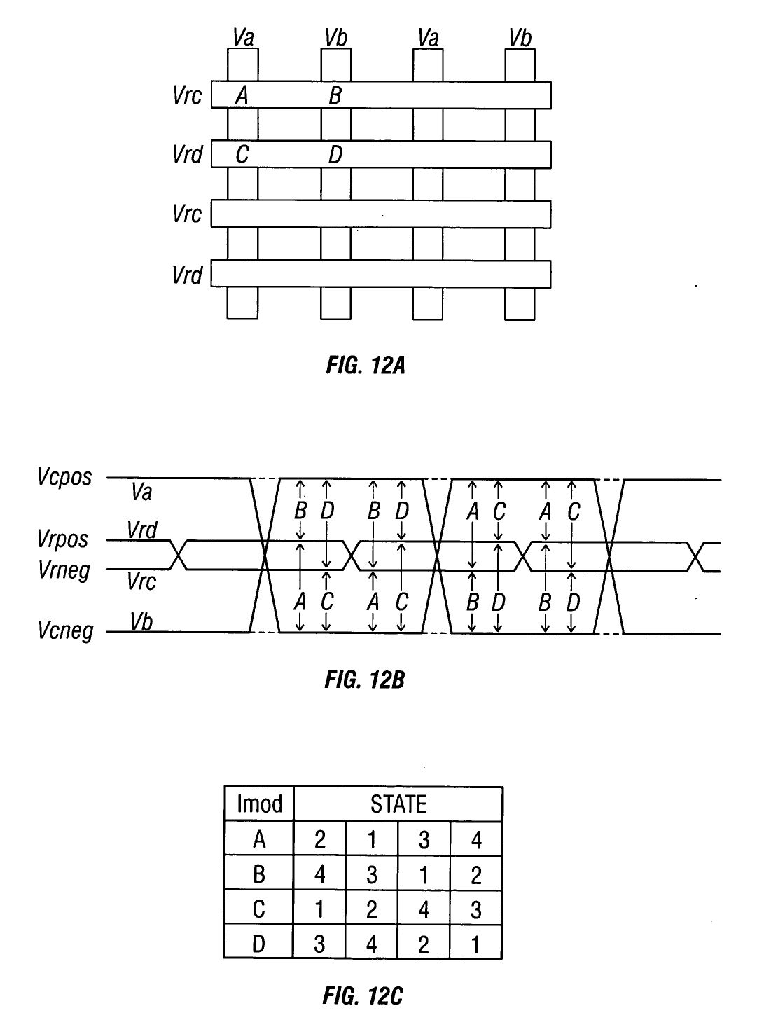

Some embodiments use both horizontal and vertical dithering to reduce the perceptible flicker while changing hold potential polarity during the hold period. FIGS. 12A and 12B are an illustration and a timing diagram showing an array of interferometric modulators and the hold potentials on the rows and columns during a hold period. FIG. 12A shows that the column potentials are not all identical. FIG. 12A also shows that the row potentials are not all identical. Although other arrangements are possible, in the embodiment shown in FIG. 12A, the row potentials vertically alternate and the column potentials horizontally alternate. That is, odd rows have a first potential Vrc and even rows have a second potential Vrd, while odd columns have a third potential Va and even columns have a fourth potential Vb. Vrc and Vrd are driven so as to switch between Vrpos and Vmeg such that when Vrc is Vrpos, Vrd is Vrneg, and when Vrc is Vrneg, Vrd is Vrpos, as shown in FIG. 12B. Similarly, Va and Vb are driven so as to switch between Vcpos and Vcneg such that when Va is Vcpos, Vb is Vcneg, and when Va is Vcneg, Vb is Vcpos, also shown in FIG. 12B. Additionally, the transitions of the row potentials may advantageously be out of phase with the transitions of the column potentials. Accordingly, each individual interferometric modulator switches between four different positions, each position corresponding to one of the four combinations of column and row voltages (Vcpos−Vrpos, Vcpos−Vrneg, Vcneg−Vrpos, and Vcneg−Vrneg), and each position resulting in a different light modulation characteristic, according to the amplitude of the potential applied. FIG. 12C shows the different reflectivities of each of the interferometric modulators labeled A, B, C, and D in FIG. 12A during the corresponding column and row voltage time period as shown in FIG. 12B, where reflectivity 1 corresponds to Vcneg−Vrneg, reflectivity 2 corresponds to Vcneg−Vrpos, reflectivity 3 corresponds to Vcpos−Vrneg, and reflectivity 4 corresponds to Vcpos−Vrpos. The table of FIG. 12C shows that in each time period there is one interferometric modulator is in each of the four states. As a result, the total light reflected from the set of four devices will not change from one time period to the next. FIG. 12C also shows that at row voltage transitions the interferometric modulators in the same column swap states, and that at column transitions the interferometric modulators in the same row swap states. Similar to the horizontal dithering described with reference to FIGS. 11A and 11B, the two-dimensional dithering further reduces the perception of flicker by ensuring that even though the light from each interferometric modulator changes with the changing hold potential, because adjacent interferometric modulators are driven to differing states, the total light from a group of four interferometric modulators remains substantially unchanged. The result is that while the desirable affects of changing hold polarities is achieved, the undesirable flicker is 2-dimensionally dithered such that its perception is reduced or substantially eliminated.

It has also been found advantageous to periodically include a release cycle for the MEMS display elements. It is advantageous to perform this release cycle for one or more rows during some of the frame update cycles. This release cycle will typically be provided relatively infrequently, such as every 100,000 or 1,000,000 frame updates, or every hour or several hours of display operation. The purpose of this periodic releasing of all or substantially all pixels is to reduce the chance that a MEMS display element that is continually actuated for a long period due to the nature of the images being displayed will become stuck in an actuated state. In the embodiment of FIG. 9, for example, period 50 could be a write+cycle that writes all the display elements of row 1 into a released state every 100,000 frame updates. The same may be done for all the rows of the display with periods 52, 54, and/or 60, 62, 64. Since they occur infrequently and for short periods, these release cycles may be widely spread in time (e.g. every 100,000 or more frame updates or every hour or more of display operation) and spread at different times over different rows of the display so as to eliminate any perceptible affect on visual appearance of the display to a normal observer.

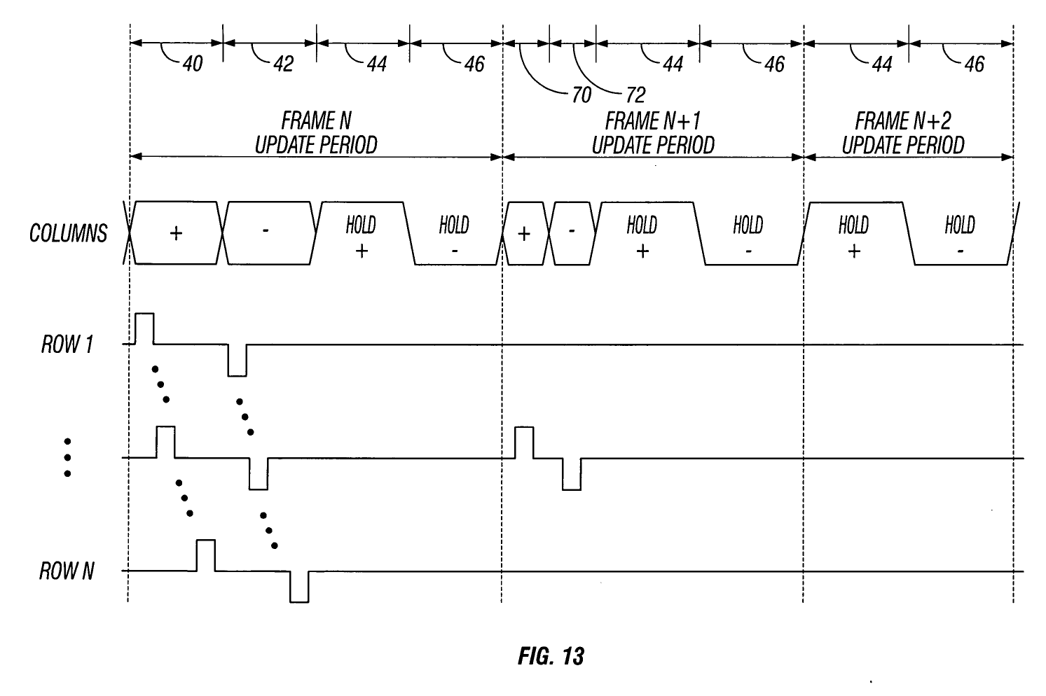

FIG. 13 shows another embodiment wherein frame writing may take a variable amount of the frame update period, and the hold cycle periods are adjusted in length in order to fill the time between completion of the display write process for one frame and the beginning of the display write process for the subsequent frame. In this embodiment, the time to write a frame of data, e.g. periods 40 and 42, may vary depending on how different a frame of data is from the preceding frame. In FIG. 13, Frame N requires a complete frame write operation, wherein all the rows of the array are strobed. To do this in both polarities requires time periods 40 and 42 as illustrated in FIGS. 9 and 10. For Frame N+1, only some of the rows require updates because in this example, the image data is the same for some of the rows of the array. Rows that are unchanged (e.g. row 1 and row N of FIG. 13) are not strobed. Writing the new data to the array thus requires shorter periods 70 and 72 since only some of the rows need to be strobed. For Frame N+1, the hold cycles 44, 46 are extended to fill the remaining time before writing Frame N+2 is to begin.

In this example, Frame N+2 is unchanged from Frame N+1. No write cycles are then needed, and the update period for Frame N+2 is completely filled with hold cycles 44 and 46. As described above, more than two hold cycles, e.g. four cycles, eight cycles, etc. could be used.

While the above disclosed embodiments have been directed toward specific arrangements of row and column drive voltages. It will be understood that other arrangements will also have the advantageous result of dithering the flicker. For example, sets of adjacent elements may be arranged such that all elements within a set receive a same drive voltage and therefore move substantially identically, and such that each set receives a different drive voltage than an adjacent set, and therefore move differently than the adjacent set. Column and Row voltages in such a scheme will be configured such that the sets of elements are of such a size and shape that the flicker is effectively dithered by their spatial arrangement.

It will be understood that in the above discussion that the term polarity relates to the sign of a difference between a value and a reference, where the reference may or may not be zero. That is, signals of opposite polarity are of such values that one is greater than the reference and one is less than the reference, where the reference may or may not be zero.

It will be understood that in the above discussion the terms row and column are arbitrarily chosen to each represent a separate dimension in an array. Rows and columns are not meant to be relative to any fixed reference. Accordingly, rows and columns may be interchanged.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A method of writing frames of display data to an array of microelectromechanical system (MEMS) display elements, said method comprising:
writing display data to said MEMS display elements to display an image;
applying a first series of bias voltages of alternating polarity to a first set of columns or rows of the array of MEMS display elements; and
applying a second series of bias voltages of alternating polarity to a second set of columns or rows of the array of MEMS display elements;
wherein said first set of columns or rows is interleaved with said second set of columns or rows such that adjacent columns or rows receive bias voltages of opposite polarity during said applying of the first series and said applying of the second series.

2. The method of claim 1, wherein the first and second series are applied to the first and second sets of columns or rows, respectively in an ABAB or an ABBA pattern, wherein A represents a column or row of the first set and B represents a column or row of the second set.

3. The method of claim 1, further comprising:
applying a third series of bias voltages of alternating polarity to a third set of columns or rows of the array of MEMS display elements; and
applying a fourth series of bias voltages of alternating polarity to a fourth set of columns or rows of the array of MEMS display elements.

4. The method of claim 3, wherein the first and second series are applied to first and second sets of columns, and the third and fourth series are applied to third and fourth sets of rows.

5. The method of claim 1, wherein the displayed image is maintained while the first and second series are applied.

6. The method of claim 1, wherein each of the elements changes from having a first light modulation characteristic to having a second light modulation characteristic in response to the application of the first and second series.

7. The method of claim 6, wherein the first and second light modulation characteristics are slightly different.

8. The method of claim 1, wherein actuated elements remain actuated and unactuated elements remain unactuated while the first and second series are applied.

9. The method of claim 1, wherein the bias voltages minimize charging of the elements.

10. The method of claim 1, wherein said first and second series of voltages are applied substantially contemporaneously.

11. A method of reducing flicker during a display hold-mode in a bistable display, said method comprising applying bias potentials of opposite polarity to adjacent rows and/or adjacent columns of the display.

12. The method of claim 11, wherein the bias potentials are applied such that hold mode flicker is spatially dithered.

13. The method of claim 12, wherein the flicker is spatially dithered in at least one of the row direction, the column direction, and both the row and the column direction.

14. The method of claim 11, wherein a first series of bias potentials of opposite polarity is applied to rows of the display and a second series of bias potentials is applied to columns of the display.

15. The method of claim 11, wherein the bias potentials minimize charging of the elements.

16. The method of claim 11, wherein said first and second series of voltages are applied substantially contemporaneously.

17. A method of driving a plurality of bistable microelectromechanical system (MEMS) display devices, the method comprising:
writing image data to the devices to display an image;
applying hold signals to the display devices, wherein the hold signals are applied to sets of display devices so as to spatially dither differences in light output such that visible flicker is reduced in said display devices during said applying, wherein the differences in light output are caused by the application of the hold signals.

18. The method of claim 17, wherein the hold signals comprise signals of at least one of opposite polarity and different amplitude.

19. The method of claim 18, wherein adjacent sets receive hold signals differing by at least one of polarity and amplitude.

20. The method of claim 17, wherein the sets comprise at least one of rows, columns, portions of rows, portions of columns, portions of multiple rows, and portions of multiple columns.

21. The method of claim 17, wherein the sets are contiguous.

22. The method of claim 17, wherein the sets are not contiguous.

23. A display device comprising:
an array of microelectromechanical system (MEMS) display elements; and
a display driver configured to supply signals to rows and columns of the array so as to display an image, to apply a first series of bias voltages of alternating polarity to a first set of columns or rows of the array, and to apply a second series of bias voltages of alternating polarity to a second set of columns or rows,
wherein said first set of columns or rows is interleaved with said second set of columns or rows such that adjacent columns or rows receive bias voltages of opposite polarity during said applying of the first series and said applying of the second series.

24. The device of claim 23, wherein the driver is further configured to apply a third series of bias voltages of alternating polarity to a third set of columns or rows of the array of MEMS display elements, and to apply a fourth series of bias voltages of alternating polarity to a fourth set of columns or rows of the array of MEMS display elements.

25. The device of claim 23, wherein the first and second series are applied to first and second sets of columns, and the third and fourth series are applied to third and fourth sets of rows.

26. The device of claim 23, wherein each of the elements is configured to change from having a first light modulation characteristic to having a second light modulation characteristic in response to the application of the first and second series.

27. The device of claim 23, wherein the array is configured such that actuated elements remain actuated and unactuated elements remain unactuated while the first and second series are applied.

28. The method of claim 23, wherein said first and second series of voltages are applied substantially contemporaneously.

29. A display device comprising:
means for displaying an image;
means for supplying signals to rows and columns of the displaying means so as to display an image;
means for applying a first series of bias voltages of alternating polarity to a first set of portions of the displaying means; and
means for applying a second series of bias voltages of alternating polarity to a second set of portions of the displaying means,
wherein said first set of portions is interleaved with said second set of portions such that adjacent portions of the displaying means receive bias voltages of opposite polarity during said applying of the first series and said applying of the second series.

30. The device of claim 29, wherein the supplying means is further configured to apply a third series of bias voltages of alternating polarity to a third set of portions of the displaying means, and to apply a fourth series of bias voltages of alternating polarity to a fourth set of portions of the displaying means.

31. The device of claim 29, wherein each of the portions of the displaying means is configured to change from having a first light modulation characteristic to having a second light modulation characteristic in response to the application of the first and second series.

32. The device of claim 29, wherein the displaying means is configured such that actuated portions of the displaying means remain actuated and unactuated portions of the displaying means remain unactuated while the first and second series are applied.
